(19) United States
(12) Patent Application Publication
(10) Pub. No.: US 2010/0023387 A1
(43) Pub. Date: Jan. 28, 2010

(54) Hierarchical User Interfaces for Advertisement Messages in a Mobile Device

(76) Inventor: Yang Pan, (US)

Correspondence Address: Yang Pan, Shimao Riviera Garden, Wei Fang Rd. (W), Lane 1, Block 9, Unit 8A, Shanghai, 200122, CN

(21) Appl. No.: 12/179,582

(22) Filed: Jul. 25, 2008

(51) Int. Cl. G06Q 30/00

(52) U.S. Cl. 705/14.4; 705/14.55; 705/14.58; 705/14.64

(57) ABSTRACT

Hierarchical categorization of advertisement messages and associated user interfaces are disclosed. A user interface with four hierarchical levels is described as an exemplary case to illustrate the invention. A user definable icon is disclosed, which assists a user to select his or her needed advertisements with the great ease. The zone of “local” area is defined by the user via adjusting the coverage of an interactive map displayed on the screen. The “locality” can be defined by a map which can be zoomed in or zoomed out or be shifted by the user. Merchandisers displayed on a “local” map can be selected by a user to view detailed advertisement messages. Further, a method for the advertising broker to track the successful rate of advertising events is disclosed by measuring if the mobile device overlaps the selected merchandiser location in exceeding of a predetermined period of time.

### CROSS-REFERENCE TO RELATED APPLICATIONS

Not applicable.

### BACKGROUND

1. Field of Invention

This invention relates generally to advertising. More specifically, the invention relates to methods and systems for providing location-based advertisements.

2. Description of Prior Art

Handheld media and communication devices such as, for example, the iPhone from Apple Inc. of Cupertino, Calif., have recently gained popularity. The device integrated with a position identification function can be used to provide location specific information to users of such devices. Position determination on mobile electronic device can be accomplished through the use of Global Positioning System (GPS) satellites. One application which uses location specific information of the mobile communication devices is advertising. It has been recognized that in order to maximize the return of on any particular advertisement, advertisers desire to provide their advertisements to a demographic which is most likely to be interested in the particular advertisement. For example, in order to minimize the expense of advertising, a small restaurant may wish to advertise only to those people who are currently in the vicinity of the restaurant, e.g. by placing the advertisement on a billboard in the vicinity of the restaurant. Accordingly, by providing the advertisement based upon location specific information, an advertiser's financial resource need not be wasted on advertisement provided to people who are not currently in the vicinity of the advertiser.

Interactive advertising by use of mobile communication devices provides opportunities for advertisers to target their advertisements to a receptive audience. That is, targeted advertisements are more likely to be useful to end users since the advertisements may be relevant to a need inferred from some user activity. Presently, the capability to push information to a mobile communication device from a networked based system through the wireless communication infrastructure exists. A number of US patents and patent applications have been published for various prior arts for location based advertisement by use of mobile communication devices. They include U.S. Pat. No. 6,650,902 to Richton, U.S. Pat. No. 6,813,501 to Kinnunen at al, U.S. Pat. No. 6,452,498 to Stewart, U.S. Pat. No. 6,505,046 to Baker, US patent application 2006/0253481 by Guido et al, US patent application 2002/0026361 by Blow and US patent application 2007/0149212 by Gupta et al. All the listed prior arts propose methods to deliver the advertisements to a user associated with a mobile communication device in a manner of pushing the location-based information to the users when the user's position is identified. The problem associated with methods of pushing advertisement messages to a user is that users may not want to be disturbed by unwanted advertisements. For example, a resident of an area, knowing the place very well, may not need advertisement messages to get necessary information, which is very much different from a tourist in the area. Sending advertisement messages to them indifferently may not yield desired advertising results. Further, it wastes network resource and, consequently, the advertiser's money to deliver messages to the users who are not interested in the advertisements.

Similarly, the ability to access information and pull it from a network based system using a mobile communication device also exists. U.S. Pat. No. 6,848,542 to Gailey et al and U.S. Pat. No. 6,944,447 to Portman et al have disclosed the prior arts to deliver location based service to a mobile communication device based upon a tailored request by the user as well as a geographic indicator associated with the device. US patent application 2005/0102180 by Gailey et al disclosed a method and system for providing advertisement effectiveness searching capabilities and usage mining in a location-based system. In such an implementation, advertisers are provided with the ability to enter a search request form on a mobile device to mine usage information. The methods for pulling information mentioned above typically depend on some type of web based service. Use of such services also requires that the mobile device include some form of browser application to access the web based service. Use of such programs can tax the already limited resource of mobile communication devices. Further, because of display limitations, viewing the information can be inconvenient and/or inefficient.

Various arts have also been disclosed to improve effectiveness and/or efficiency of delivering location-based service to a user. US patent application 2006/0200384 by Arutunian et al disclosed an art to provide interactive map information which allows a user to zoom from a large geographical area on the map to a smaller area. The map may comprise at least one data overlay that includes indications of commercial points of interest. US patent application 2002/0046084 by Steele et al disclosed an art to use internet radio to deliver location based service to a user. The radio is programmable off-line via a web page and remote computer. In another US patent application 2007/0061245 by Ramer et al, the inventors disclosed an art to provide an improved method to deliver the location-based service to a user. The method includes tracking a mobile communication device, presenting search results based at least in part on a first location, and presenting updated search results based at least in part on a second location, including a predicted second location. Another US patent application 2004/0076279 by Taschereau disclosed a system and method of providing information based on location of target. The system can target advertisements to users based on the location of the user, a destination location related to the information requested by the user and/or route to be taken by the user to reach such destination. A U.S. Pat. No. 6,542,822 granted to Froeberg described a method and system for dynamically communicating content to an occupant of a moving vehicle according to the location and direction of travel of vehicle. Using the vehicle's position and direction of travel as well as other factors such as time of day, a particular item of content can be selected and communicated to an occupant of the vehicle.

Location-based services are mostly pushed to a user with a mobile communication device in a form of a text messages (SMS) or audio and/or video messages. The delivered messages disturb a user if the user is not interested in such commercial information. Moreover, it would be difficult for an advertisement broker to delivery a user desired advertisement message at a specific location and at a specific time of a day. In order to improve the effectiveness of the advertisement, the broker has to deliver a significant amount of messages to test the user's interests if any. On the other hand, the user has to extract a message which he is interested in from a large number of unwanted messages. A message generated by a user's search action may reduce negative impacts of the above mentioned issues. However, a mobile device with a small display screen is not in particularly suitable for the purpose of browsing of web sites.

Accordingly, it is a purpose of the present invention to provide a hierarchical user interface in a mobile communication device. It allows a user, guided progressively by the hierarchical interfaces from the highest order to the lowest order, to access desired advertisement messages in a user friendly manner, which fits the small display screen of a mobile communication device.

It is a further purpose of the present invention to provide a method to define a user specified local zone to receive advertisement services provided by an advertising server. The local zone is defined by use of an interactive map displayed on a screen of the mobile device. The coverage area may be adjustable by the user.

It is still a further purpose of the present invention to provide a method to assist a user to access advertisement messages by use of a user definable icon on display screen of a mobile device.

It is still a further purpose of the present invention to provide a method that an advertising broker can track a user's selection of a specific advertisement and follow the movement of the mobile device after the user viewing the message. A successful event of the advertising can be established if the position of the mobile device overlaps the advertiser's location in exceeding of a predetermined period of time.

### SUMMARY OF THE INVENTION

A variety of technologies related to providing location-based service within wireless network can be applied. The present invention provides methods and systems for location-based advertising. More specifically, the present invention employs an advertisement broker operating an advertising server, which interacts with advertisers through a communication network such as the internet and provides advertisement messages to a plurality of mobile devices connected to the advertising server through a mobile Internet Service Provider (ISP).

The present invention discloses a hierarchical categorization of the advertisement messages. Hierarchical user interfaces resulted from the hierarchical categorization direct a user to access an advertisement message which the user is interested in. The interfaces are in particularly suitable for a mobile communication device with a relatively small display screen. The four-level hierarchical interfaces are used as an exemplary illustration for the invention although more or less levels can be used depending on specific applications. A touch-screen type of display and the associated user interfaces are used as an example for describing the invention. This should again not limit the scope of the present invention. Embodiments with other input means can be implemented in straightforward manners for those familiar with the art. A touch-screen is a display which can detect the location of touches within display area, usually performed either with the human hand or a stylus. A plurality of user selectable subcategories is displayed on the screen in the form of icons similar to the ones employed in the iPhone from Apple. The icons include representative items for typical functions associated with a mobile communication device such as, for example, the voice communication, the digital camera and the media player etc. In the present invention, in the first hierarchical level, an icon for viewing location-based advertisements is displayed on the screen along with other conventional ones. Without a user's input action on the icon, no advertisement messages are visible to the user, which gives the user the peace of mind if he or she is not interested in any advertisement message.

When a user intends to view an advertisement, one selects the displayed icon associated with advertisement messages. The mobile device receives the user's input action and displays second hierarchical user interface with subcategories for various advertisements. The subcategories are represented by icons with intuitive visual symbols associated with represented advisers in an intuitive manner. The subcategories include typically local merchandisers such as, for example, restaurants, shops, banks and movie theaters etc. They include at least one user-definable icon. A user can input an action such as, for example, selecting and then pulling the icon along one direction horizontally by use of the stylus, to expand the size of the icon. The user can write-in or key in at least one keyword associated with a specific group of merchandisers. If the action is carried out, the mobile device replaces the keyword or words with an associated intuitive visual symbol. The user can keep the defined icon for future usage or delete it after use.

After viewing the subcategories of the advertisement, the user can select one of them interested to him or her. After receiving the user's input action, the third hierarchical user interface is displayed on the screen replacing the second one. The third hierarchical level interface displays a local map with indicated name and/or logo's as well as associated location of merchandisers, who employed the internet advertisement broker, in the selected subcategory. After viewing the location of the merchandisers on the map, the user may decide to select one of them by touching the spot on the screen associated with the specific merchandiser. After receiving the user's selection, the mobile communication device replaces the third hierarchical level user interface with a forth one, which is a detailed presentation of the selected merchandiser. The user can further select associated icons on the screen displayed by the forth hierarchical interface to view even more detailed information about the merchandiser. One aspect of the present invention is that a user can zoom in or zoom out or shift the map. The coverage of the map on the display screen defines the zone of the location associated with the received advertisement service. It is important to take a user's view on the area of service he or she needs. As the coverage of the map changes, the number of merchandisers on the map is changed accordingly. Further, the user can shift the map to a zone beyond the current location, for example, the user is driving and wants to know merchandisers near the destination of the journey. The hierarchical user interface described in the present invention allows the user to define a zone of the received services and communicate with the advertising server and receive the needed information accordingly.

When a user selects an icon related to a specific subcategory representing a group of merchandisers, the mobile communication device receives the user's input and sends the selection to the advertising server. The server extracts the related advertisement messages from all updated ones associated with the location. The number of advertisement messages to be sent to the mobile device is much reduced by limiting the messages to the selected subcategory. The files are sent to the mobile device sequentially based upon their priorities. A file containing historical selection patterns of the user can be used to assign the priority for each file. For example, it may be recorded that the user has a high probability to select a French restaurant when he uses the location-based service while he is looking into a subcategory of “Restaurant”. In such a circumstance, the server sends all local French restaurant related advertisements to the user's mobile device with higher priorities. Further, the historical selection patterns of the user may also indicate the price range that the user has higher probability to accept. Thus the advertising server can rank the selected French restaurants based upon the price range.

One aspect of the present invention is that advertisements may be sent to the user's mobile device in anticipating the user's more probable selections based upon the user's present and historical interaction patterns. A user may spend some time to review a map and the displayed merchandisers. The advertisements are delivered while the user is viewing the map. A user will have a much smoother experience to acquire the interested advertisement when it is finally selected. In view that an advertisement can be in a form of multimedia files, delivering the contents ahead of the user's final selection would enhance the user's experience of use the system and improve the user's satisfaction. The process is dynamically adjusted based upon the latest user interaction with the input device. The mobile device sends each of user's action to the server. The server receives continuously the user's input actions and adjusts its operation with regard to the selecting, ranking and delivering the advertisements to the user. For example, if the server detects that a user's selection deviates from what the server predicts, the system changes its operation accordingly to deliver the advertisements that the user desires.

Another aspect of the present invention is that certain tasks associated with the delivery of the location-based advertisement to a user's mobile device can be accomplished without a user's notification. When a user carrying a mobile communication device enters a specific location, the server receives the device identity. The metadata associated with merchandisers in the region stored in the user's mobile device is then sent to the server after the local zone is established by the user. The metadata typically includes the names of merchandisers and its address only. The server receives the metadata and compares with the latest updates in the server. If any difference is detected by the server, an updated metadata file about merchandisers and their locations is then sent to the mobile device. The device updates the metadata file, displays them on the screen if it is applicable and stores them in its file system. The operation can be carried out without the user's notification.

Another aspect of the present invention is that the system allows the advertisement broker to track the success rate of a specific advertising operation. After the user views the advertisement, he or she makes the decision to use the selected merchandiser. The integrated GPS system is able to report if a user is actually spend time at the merchandiser. The advertisement broker can charge the advertiser accordingly based on such recorded successful advertising events.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a server used by an advertisement broker receiving real time location-based advertisements from advertisers and sending to a plurality of mobile communication devices through communication networks.

FIG. 2 is a schematic diagram of a mobile communication device with four levels of hierarchical user interfaces directing, progressively, a user to view a desired advertisement.

FIG. 3 is a diagram and a flow chart showing that an icon for a subcategory of advertisement messages can be the user definable.

FIG. 4 is a schematic diagram showing a structure of four level hierarchical user interfaces.

FIG. 5 is a schematic diagram showing a structure that an additional level of subcategory can be inserted.

FIG. 6 is a schematic diagram of the forth level user interface showing a presentation of an advertisement to a user.

FIG. 7 is a flow diagram showing a process that a user accesses a desired advertisement with the use of hierarchical user interfaces.

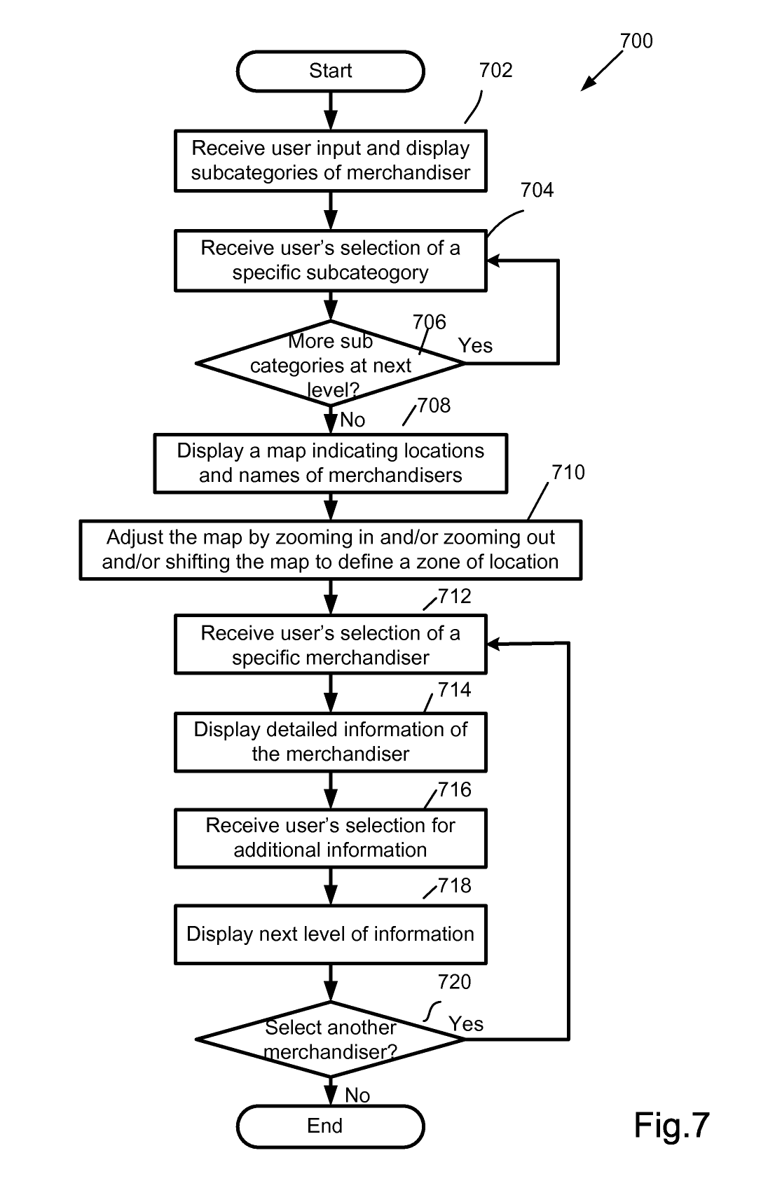

FIG. 8 is a flow diagram showing a process that targeted advertisements are selected and delivered based upon the user's location, the interaction with the user interfaces and the historical selection patterns.

FIG. 9 is a flow diagram showing a process that the metadata associated with location-based merchandisers are updated automatically in a manner that the user may not be notified.

FIG. 10 is a flow diagram showing that an advertisement broker tracks if an advertising operation is successful.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

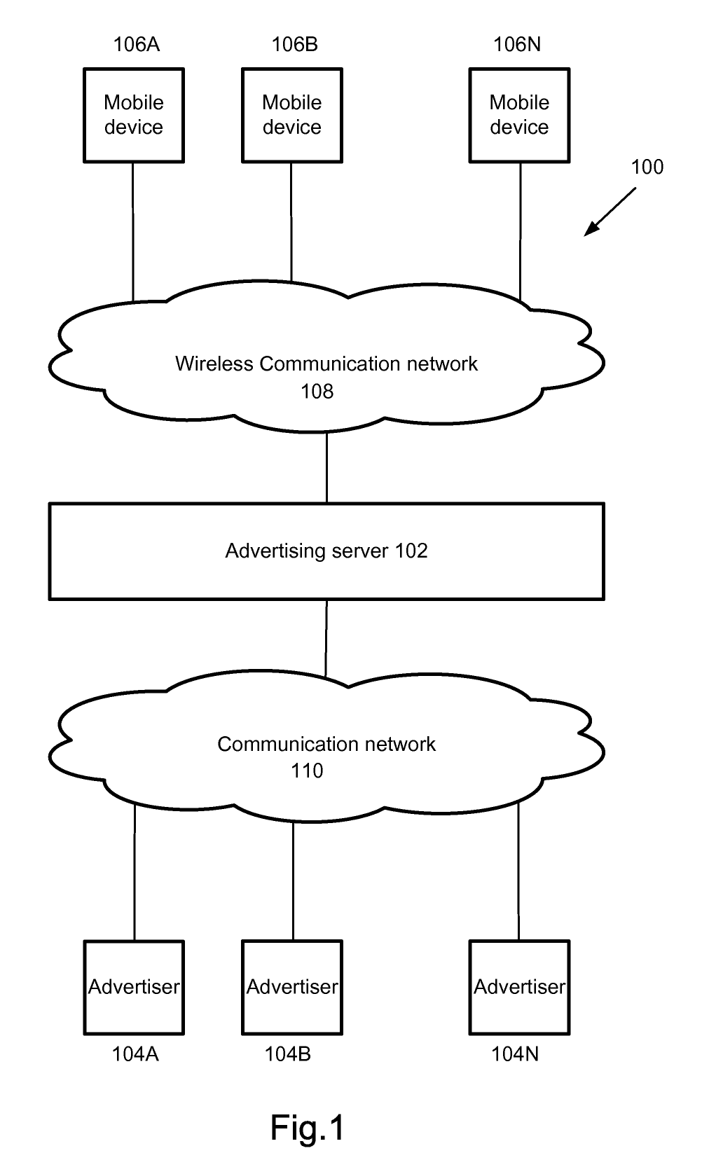

FIG. 1 is a schematic diagram of an exemplary communication system 100 for distributing location-based advertisements. An advertising server 102 is used by an advertisement broker receiving real time location-based advertisements from advertisers 104 and sending to a plurality of mobile communication devices 106. The mobile devices 106A, 106B, . . . , 106N are geographically distributed throughout an area, such as, for example, a shopping area, a city, a region, etc. In various embodiments, each mobile device may communicate with an advertising server 102 through a wireless communication network 108. The wireless communication network can take various forms such as the internet, a W-LAN or other suitable communication network. A plurality of advertisers 104A, 104B, . . . , 104N may also communicate with the advertising server 102 over a communication network 110. In various embodiments network 108 and 110 may be the same network, however, in various other embodiments, the network 108 and 110 may be different networks. In various embodiment, the advertisers 104A, 104B, . . . , 104N may communicate with the advertising server 102 for a number of reasons, including, purchasing advertisement space and uploading advertisement messages. In the present invention, the advertisement messages from the advertisers to the advertising server are updated continuously on a real time base.

It should be noted that system depicted in FIG. 1 shows a single advertising server 102 for ease of illustration purpose only. Various embodiments may use multiple servers in a manner that is either apparent or transparent to the communication system and its users.

Mobile devices 106A, 106B, . . . , 106N may comprise a display screen, such as, for example, a Liquid Crystal Display (LCD) screen, a processor, a signal processing unit and a file system. In an exemplary case, the display includes one or more interactive features which allow viewers to interact with display to obtain desired product information guided by hierarchical user interfaces. In one embodiment, the interactive display is a touch-screen type of display as the one used in iPhone from Apple. A touch-screen is a display which can detect the location of touches within display area, usually performed either with the human hand or a stylus. The mobile device may also comprise a Global Positioning System (GPS) to identify the position of a mobile device. Recently, GPS has been developed to the point where they are very inexpensive to implement in a mobile device.

In various embodiments of the invention, advertisements may include text, graphics, video, audio and multimedia messages. It should be appreciated that while advertisement messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computer systems, or other definable concepts or content may be used. Thus although the use of advertisement messages are described herein as examples, other documents such as web pages may be targeted to viewers and displayed in accordance the various embodiments, e.g. as described herein with respect to advertisement messages.

It should be understood that an advertisement message as used herein may comprise audio and/or video signals, static and/or dynamic images, graphics, video, film, or other content that relate to one or more products, services, and/or entities, such as commercial entities. Advertisement messages may also comprise various visual features, including animation, sound etc., and may include text, such as in a text advertisement. Thus, the term “advertisement message” is used herein in its broadest sense to include any content or object intended for observation, use, or consumption by one or more persons for the purpose of marketing or promoting a product or service. While, advertisement messages are used for exemplary purpose, it should be understood that any audio and/or video content, such as television programming, may be used with the systems and methods described herein.

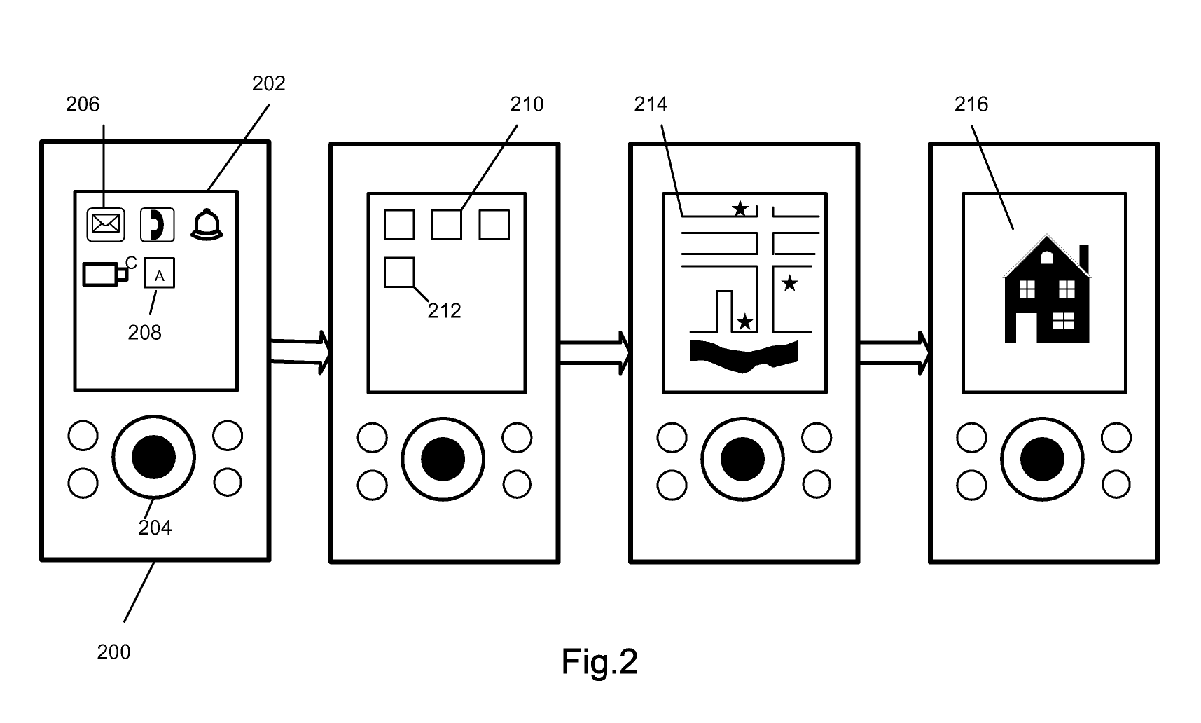

FIG. 2 is a schematic diagram of a mobile communication device with four levels of hierarchical user interfaces directing, progressively, a user to view a desired advertisement message. A mobile device 200 is with a display screen 202 such as a LCD screen, a user input device or devices 204 and a plurality of icons 206. The first level of the hierarchical user interface includes a plurality of user selectable items represented by each individual icon. The icons have been used in computers and mobile devices widely to provide a user friendly interface. In an implementation of a touch-screen, the directory or folder represented by an icon can be accessed by a user touching the icon using a finger or a stylus. The icons for a mobile device typically include ones for voice communication, email, internet browser and digital camera etc. In FIG. 2, an additional icon 208 is added in present invention. A user of the mobile device can access location-based advertisement by open up the folder represented by this specific icon. If the user does not want to be disturbed by advertisements, he or she can simply avoid an interaction with the icon representing a folder containing advertisement messages.

After the user actuates the icon associated with the advertisement, the mobile device displays the second hierarchical level user interface. A plurality of icons 210 representing subcategories of various merchandisers is displayed on the screen. The icons may represent the merchandiser group as “Restaurant”, “Movie theater” and “Supermarket” etc. Icon 212 is a user definable one that represents a group of merchandisers defined by the user. For example, a user may assign such an icon to “Starbuck’, a well-known coffee retailer chain. The user can keep such an assignment and he or she can use this icon to view Starbuck related advertisements each time the icon is touched. If a user selects one of the icons, the third hierarchical level user interface is displayed on the screen that is a local map 214 with a specific group of merchandisers represented by the icon indicated on the map as marked by stars, which may be the names and logos associated with specific merchandisers. The user may select a specific merchandiser by touching the associated spot on the map in case of touch-screen type of user interface. The forth hierarchical level user interface is then displayed with detailed advertisement messages of the selected merchandiser. The user can review the message and decide if he or she wants to purchase products or services from the merchandiser.

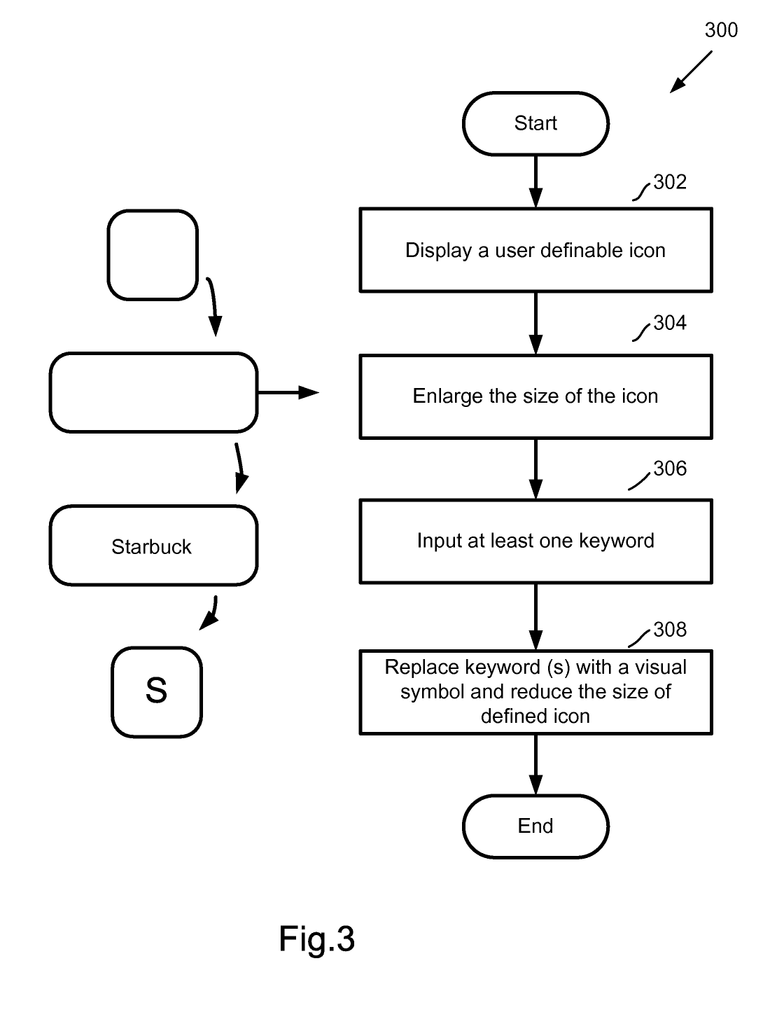

FIG. 3 is a diagram and a flow chart showing that an icon for a subcategory can be user definable in a process 300. The hierarchical user interface at the second level displays multiple icons representing the specific group of merchandisers. At least one user definable icon is displayed on the screen in a step 302. A user can input an action as shown in a step 304, for example, selecting and then pulling the icon along one direction horizontally by use of the stylus, to expand the size of the icon. Following by a step 306, the user inputs at least one keyword with clear visibility representing a group of merchandisers that the user is interested in. When the icon is selected later, the merchandisers represented by the keyword will be displayed at the next level of the hierarchical user interface. Further, the processor of the mobile device replaces the keyword (s) with an intuitive visual symbol in a step 308. The size of the icon is then reduced to the one similar to others on the screen. The second level hierarchical user interface may have a plurality of mixed icons defined by the system and defined by the user. At least one user definable icon is displayed on the screen. If the one has been used up by the user, a new one is then displayed on the screen controlled by the processor of the mobile device.

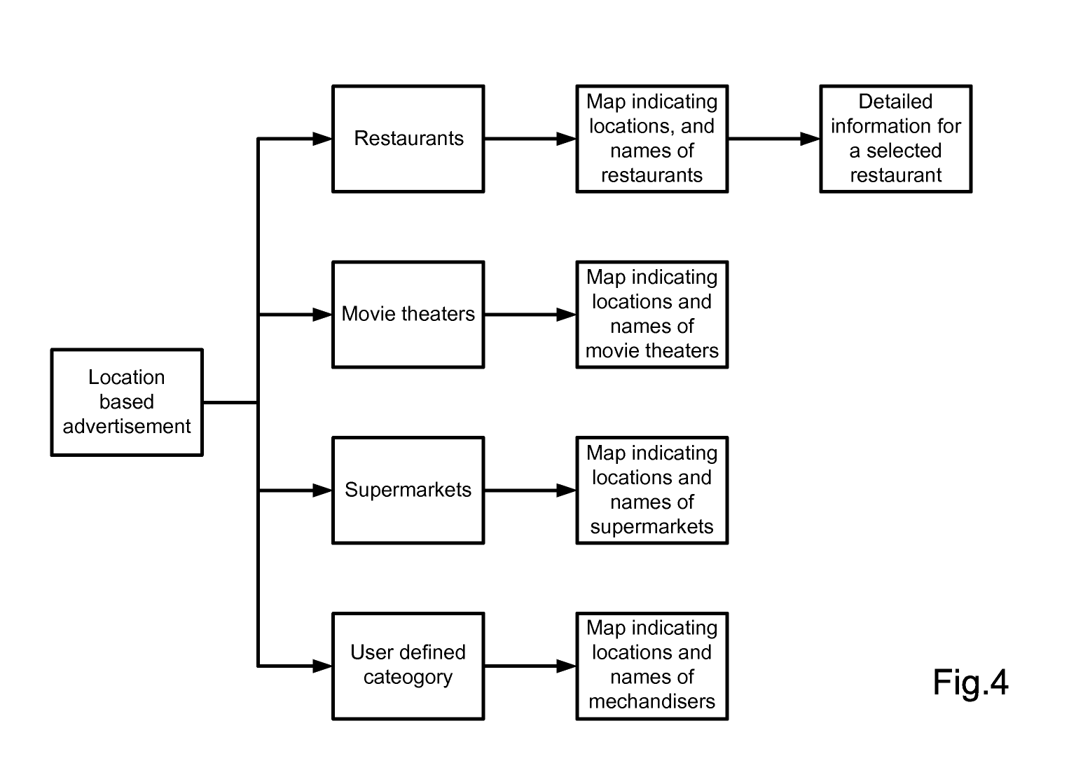

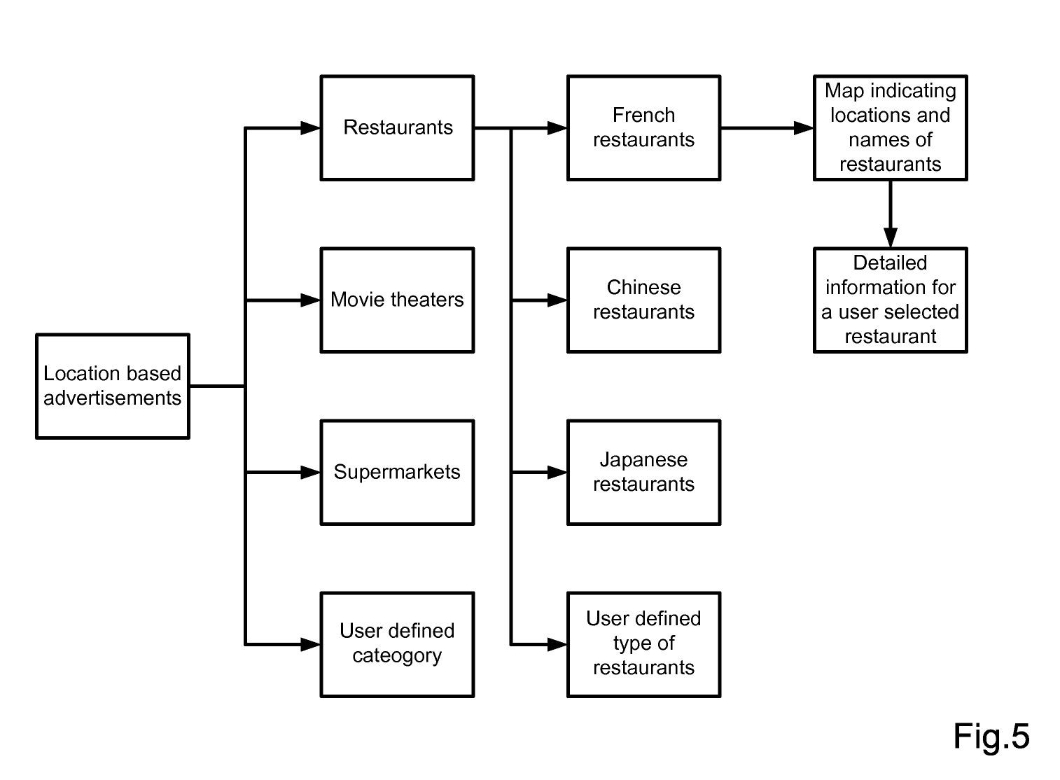

FIG. 4 is a schematic diagram showing a structure of four level hierarchical user interfaces. Herein, an exemplary case of a user looking for a restaurant is used to illustrate the user interface. The user selects the icon on the first level of the interface to enter the folders for advertisement messages. On the second screen, a number of icons representing such merchandisers as “Restaurant”, “Movie theater”, “Supermarket” etc are displayed. The user selects the icon representing “Restaurant” and a local map indicating all restaurants who subscribe to the advertising broker is then displayed on the screen. The user reviews the name (logo), location of the restaurants and may decide to select one for further review. After the selection, detailed advertisement messages, presenting to the user in a designed format, are displayed on the screen for the further review. The user may decide to select the restaurant for a dining experience or go back to the map to select another restaurant for review. We have used four hierarchical level user interfaces to illustrate the present invention. It should be noted that more levels may be added in between the second and the third levels for more specific selections. As shown in FIG. 5, after the user selects the icon for “Restaurant”, a plurality of icons representing different type of restaurants is shown on the screen such as “French”, “Chinese”, “Japanese” and any other specific types defined by the user. The user's selection of, for example, “French” leads to a screen displayed with a local map indicating all French restaurants who subscribe for the advertising service.

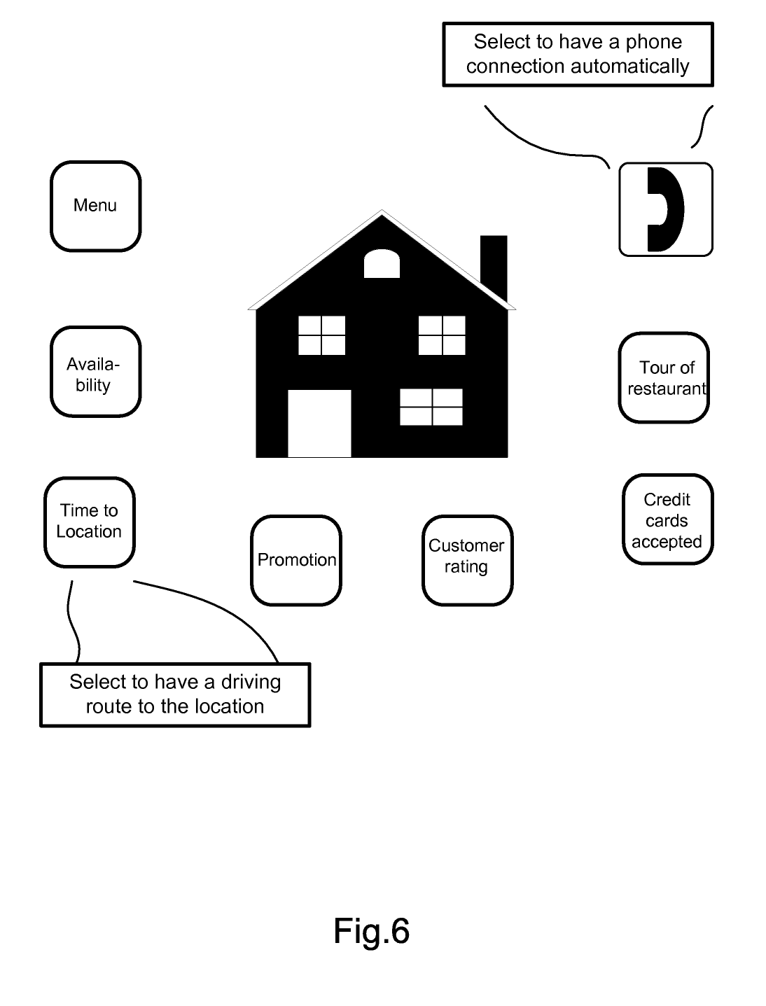

FIG. 6 is a schematic diagram of the forth level user interface showing an implementation of the presentation of an advertisement to a user. A restaurant is taken as an exemplary illustration. The displayed messages may include but not limited to a photograph of the restaurant and other icons as “Menu”, “Customer rating” and “Promotions” etc. An icon with a symbol of telephone is used for the user to connect to the restaurant for a reservation or for more information. When the icon is actuated, the mobile device connects to the restaurant automatically for a voice-based communication. Thus it is not necessary for the user to key-in the phone number to make a call. Further, an icon with an indication of “Time to Location” is displayed to indicate the estimated time required for the user to reach the restaurant by driving a vehicle. If the icon is selected, a driving route is displayed for guiding the user to drive from the current location to the restaurant. The user may also select an icon for a visual tour of restaurant with the presentation of a number of photographs and/or the presentation of the restaurant with audio and/or audio/video files. Various embodiments can be implemented to enhance the user experience and help the user to select the merchandiser.

In another aspect of the invention, the user may adjust the coverage of the map. In the prior arts, when a ‘location’-based service is mentioned, it typically lacks of a clear definition of the locality. It is an object of the present invention to provide method to have a user defined zone to receive services. It is indeed important that a user selects the zone of service. The operation of adjusting the coverage is typically performed by a user zooming in or zooming out an interactive map by the user's input actions. Further, the user may shift the map from one location to another. For example, if the user is in a moving vehicle, he or she may be interested in merchandisers near the destination of the trip. In such a circumstance, the user can shift the interactive map to around the final destination. It is a prior art to zoom in or zoom out or shift the location for an interactive map as implemented in Google Maps. In the present invention the “location” accessible by the advertisement service is defined by the map and therefore by the user. Further, “location” is dynamic. The user can change it anytime he or she feels it is needed. It should be noted that the number of merchandisers indicated on the map varies when the coverage of the map is changed. It should be noted that when use the map to define the local zone to receive the service from the server, it is not necessary to send the extensive information associated with the map to the server. Many methods can be implemented by one familiar with the art to transmit a defined zone, which include one implementation to take four positioning coordinates at four corners of the map and send the coordinates to the server.

The process 700 starts with a step 702 that the mobile device receives the user's selection of entering the folder containing advertisements. A plurality of subcategories representing the various merchandisers is then displayed on the screen. In the step 704, the mobile device receives the user's selection of a specific group of the merchandisers as represented by an associated icon. The processor of the mobile device checks if there is next level of subcategories for the selected item in the step 706. If the response is positive, the subcategories in next hierarchical level are displayed and a user can make a further selection. Otherwise, a map indicating location and names of the merchandisers associated with the selected subcategories is displayed in a step 708. The user may zoom in or zoom out or shift the map to have a properly defined ‘location’ in a step 710. The mobile device receives the user's selection of a specific merchandiser in a step 712 and displays detailed advertisement messages on the screen of the mobile device in a step 714. The mobile device receives further selection of user selectable items for revealing more information about the merchandiser to the user in the steps 716 and 718. The mobile device checks if the user selects the merchandiser or goes back to the map for another selection in the step 720 till a merchandiser is finally selected or the user leaves the folder of the subcategory.

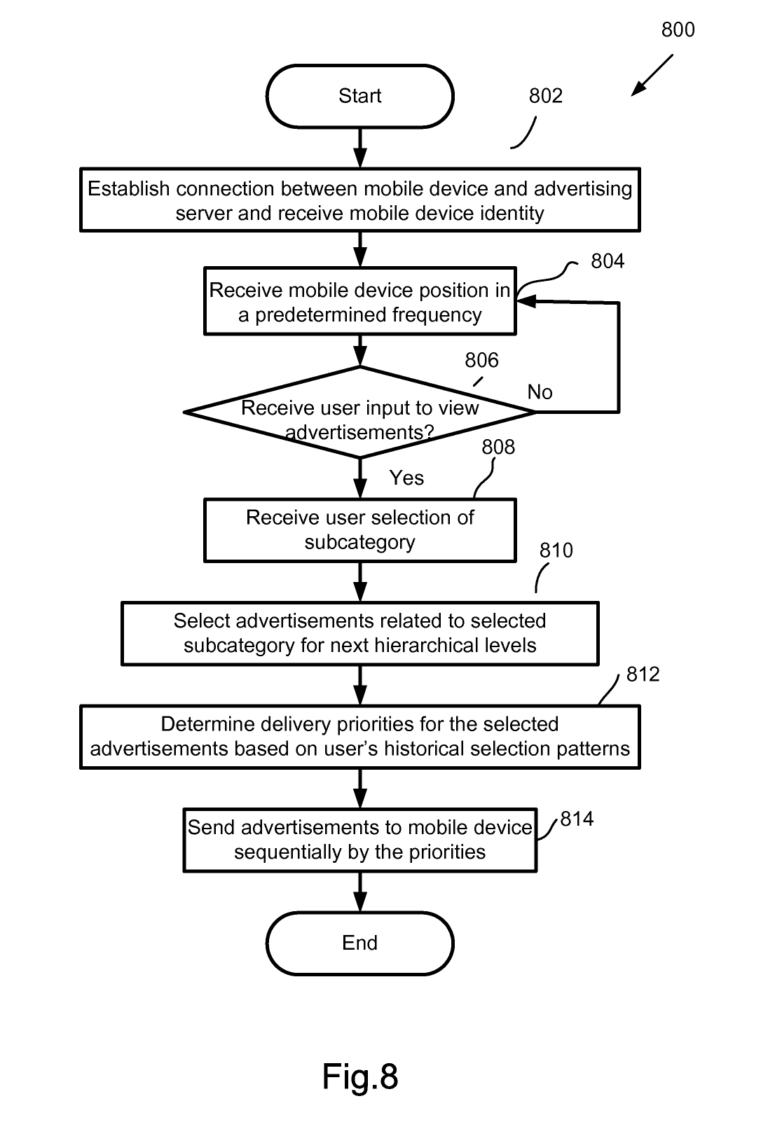

FIG. 8 is a flow diagram showing a process that advertisements are selected and delivered based upon the “defined” user's location, the user's interaction with the device interface and the historical selection patterns by the user. The process 800 starts with a step 802 establishing a connection between the mobile device and the advertising server. The mobile device sends its identity such as, for example, a mobile phone number to the server while connected. In a step 804, the mobile device sends its position continuously in a pre-determined frequency to the server so the latest position of the user can be identified by the server when the user is moving. In the step 806, the server checks if a signal is received that the user decides to enter the folder for the advertisement messages. If the response is negative, the server continues to monitor the user's location and his or her interactions with the mobile device. Otherwise, the mobile device displays the icons for subcategories and receives the user's selection in the step 808. The advertising server then selects the location-based advertisements from the advertisers in the group of the subcategory the user selected in the step 810. The server then determines the delivery priorities in the step 812 for the selected advertisement messages based upon the historical selection patterns of the user. The file is recorded in the server or in the mobile device which is then delivered to the server. For example, if the history records show that the user is most likely to select a French restaurant, the server sends the French restaurant related advertisement messages to the mobile device at higher priority when the subcategory of “Restaurant” is selected. The server then sends the advertisement messages to the mobile device sequentially based upon the determined priority in the step 814.

It should be noted that advertisements may be sent to the user's mobile device in anticipating the user's more probable selections based upon the user's present and historical interaction patterns. A user may spend some time to review a map and the displayed merchandisers. The advertisements are delivered while the user is viewing the map. A user will have a much smoother experience to acquire the interested advertisement when it is finally selected. In view that an advertisement can be in a form of multimedia files, delivering the contents ahead of the user's final selection would enhance the user's experience of use the system and improve the user's satisfaction. The process is dynamically adjusted based upon the latest user interaction with the input device. The mobile device sends each of user's action to the server. The server receives continuously the user's input actions and adjusts its operation with regard to the selecting, ranking and delivering the advertisements to the user. For example, if the server detects that a user's selection deviates from what the server predicts, the system changes its operation accordingly to deliver the advertisements that the user desires.

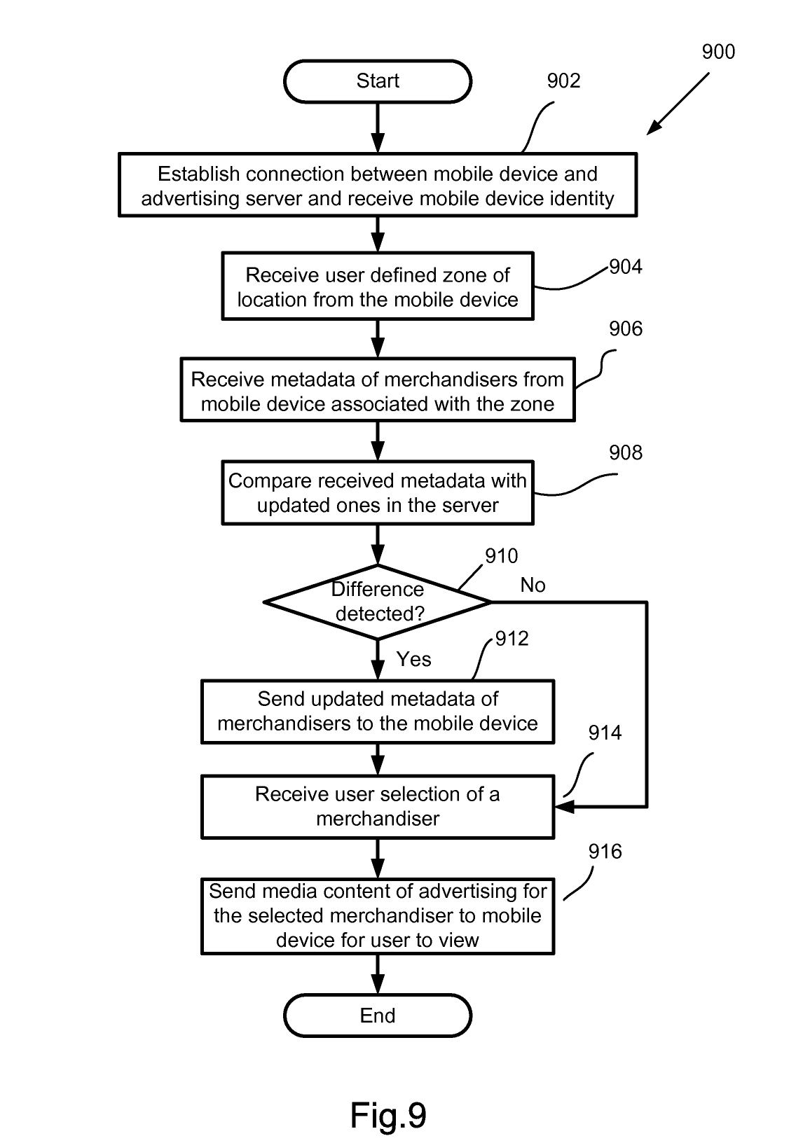

FIG. 9 is a flow diagram showing a process that metadata associated with location-based merchandisers are updated automatically in a manner that a user may not be notified. The process 900 starts with a step 902 to establish the connection between the mobile device and the advertising server. The mobile device sends continuously its position or the zone of interests defined by the user by manipulating the interactive map to the server in a predetermined frequency in the step 904. The server receives metadata of associated merchandisers from the mobile device in a step 906. The metadata contains basically names, addresses and logos of the merchandisers. The server compares the received metadata with the latest ones in the server in the step 908. If there is a detected difference (910), the server sends the latest metadata of the merchandisers to the mobile device in the step 912. In the step 914, the advertising server receives the user's selection of a specific merchandiser via the hierarchical user interfaces as described before. The server sends the advertisement message related to the merchandiser to the mobile device for the user's review in the step 916.

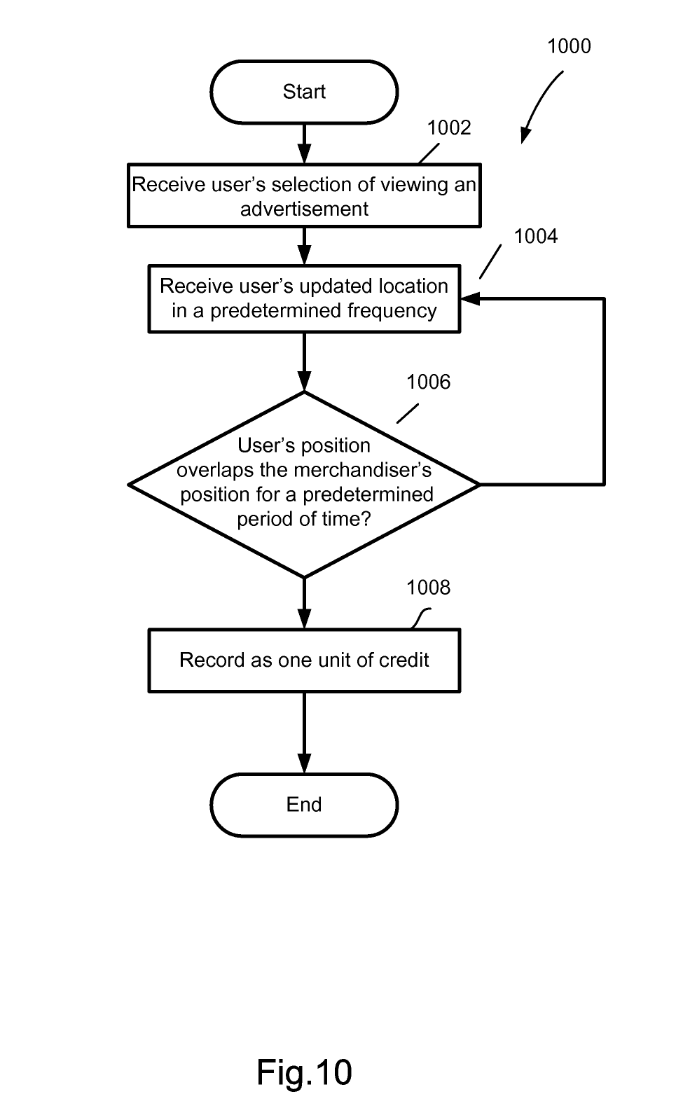

FIG. 10 is a flow diagram showing that an advertisement broker tracks if an advertising operation is successful. The process 1000 starts with a step 1002 that the server receives a signal that the user is taking a user input action to view a specific advertisement. The server receives the user's updated position continuously at a step 1004 at a predetermined frequency. If the server detects that the user with the mobile device overlaps the merchandiser's position in exceeding of a predetermined period of time at a step 1006, the server takes this event as a successful one in the step 1008 and can record as one credit. The advertisement broker operating the advertising server can charge the advertisers based upon the successful events of the advertising.

While the invention has been disclosed with respect to a limited number of embodiments, numerous modifications and variations will be appreciated by those skilled in the art. It is intended that all such variations and modifications fall with in the scope of the following claims:

1. A method of selecting at least one media content for advertising from a plurality of media contents for advertising in a mobile device, the method comprising:
displaying in the first display screen a user interface having at least one of a user selectable items for a category that includes media contents for advertising and;
receiving a user's selection for said item for said contents for advertising and;
displaying in the second display screen a list of user selectable items for a plurality of subcategories that include media contents for advertising and;
receiving a user's selection of one of said subcategories and;
displaying in the third display screen a map indicating a plurality of merchandisers in said selected subcategory and;
receiving a user selection of one of said merchandisers and;
displaying in the forth display screen said media content for advertising from the selected merchandiser.

2. A method as recited in claim 1, wherein said mobile device is a handheld media and communication device with a means connecting to the internet and a means for voice communication and it further comprising:
a display including a Liquid Crystal Display (LCD) and;
a position identification device, including a Global Positioning System (GPS), providing means to identify the position of said mobile device and;
a user input device providing means to receive user's input actions and;
a file storage system providing means to store data files and;
a processor providing means to control the operation of said mobile device and;
a power supply providing means to supply power to said mobile device.

3. A method as recited in claim 1, wherein said mobile device includes a touch-screen type of input device.

4. A method as recited in claim 1, wherein said user selectable items in the first display screen are user selectable icons.

5. A method as recited in claim 1, wherein said subcategories in the second display screen include at least one user definable subcategory.

6. A method as recited in claim 5, wherein said user definable subcategory can be defined by a user inputting at least one keyword associated with a group of merchandisers.

7. A method as recited in claim 1, wherein said map in third display screen is a map representing a predetermined area surrounding the said mobile device.

8. A method as recited in claim 1, wherein said media content for advertising in forth display screen includes:
an icon representing a telephone and;
an icon indicating the estimated required time by driving to the location of the selected merchandiser.

9. A method as recited in claim 8, wherein said first icon, if actuated by a user, resulting in establishing a voice communication means between the mobile device and the merchandiser.

10. A method as recited in claim 8, wherein said second icon, if actuated by a user, resulting in displaying a driving route to the merchandiser.

11. A method of delivering media contents for advertising to a user's mobile device from a server, both are connected to the internet, the method comprising:
displaying a map on a screen of said mobile device and;
adjusting the coverage of said map by user input actions and;
sending at least the sufficient amount of information defining a zone associated with said adjusted map to said server from said mobile device and;
sending at least portion of media contents for advertising from advertisers associated with said zone to said mobile device from said server and;
displaying at least portion of received media contents for advertising on locations in said map associated with related advertisers.

12. A method as recited in claim 11, wherein said the operation of sending media contents for advertising is accomplished sequentially based upon priorities of said contents for advertising.

13. A method as recited in claim 12, wherein said priorities are ranked based upon a historical file of said user's interaction patterns when used said mobile device for viewing media contents for advertising.

14. A method as recited in claim 11, wherein said mobile device is with an integrated position identification device including a GPS.

15. A method as recited in claim 11, wherein said “the sufficient amount of information” includes four positioning coordinates at four corners of said map.

16. A method as recited in claim 11, wherein said “adjusting” actions include:
zooming in said map and;
zooming out said map and;
shifting said map along a user selected direction.

17. A method as recited in claim 11, wherein said “portion of media contents” includes metadata of said advertisers.

18. A method as recited in claim 17, wherein said metadata includes names, logos and addresses of advertisers.

19. A method of assisting a user to access media contents by use of an electronics device, the method comprising:
displaying an unused icon on a display screen and;
enlarging the size of said icon by user's input actions and;
inputting at least one keyword related to said media contents and;
replacing said keyword(s) by an intuitive visual symbol and;
actuating said icon to access said media contents.

20. A method of tracking if an advertising event is successful by the use of a mobile device and a server, both are connected to the internet, the method comprising:
receiving by said server a selection of an advertiser from a user carrying said mobile device and;
receiving continuously said mobile device positions in a predetermined frequency and;
establishing a successful event of advertising if said mobile device's geographical position overlaps said advertiser's geographical position in exceeding of a predetermined period of time.
